(19) United States
(12) Patent Application Publication
(10) Pub. No.: US 2026/0260317 A1
(43) Pub. Date: Sep. 3, 2026

(54) A PROCESSING METHOD OF AN IMAGE FOR DETERMINING A FREQUENCY MAP AND CORRESPONDING APPARATUS

(71) Applicant: InterDigital CE Patent Holdings, SAS, Paris (FR)

(72) Inventors: Erik REINHARD, HEDE-BAZOUGES (FR); Claire-Helene DEMARTY, MONTREUIL LE GAST (FR); Laurent BLONDE, THORIGNE-FOUILLARD (FR); Franck AUMONT, VERN SUR SEICHE (FR); Olivier LE MEUR, TALENSAC (FR)

(21) Appl. No.: 19/474,602

(22) PCT Filed: Mar. 29, 2024
(86) PCT No.: PCT/EP2024/058762

§ 371 Date: Oct. 10, 2025

(30) Foreign Application Priority Data
Apr. 13, 2023 (EP) 23305558.1

(51) Int. Cl. G06T 5/10; G06T 5/20; G06T 5/94

(52) U.S. Cl. CPC G06T 5/10; G06T 5/20; G06T 5/94; G06T 2207/20064

(57) ABSTRACT

A processing method is disclosed. For at least one pixel of an image, a contrast sensitivity value, for each frequency of a set of frequencies; is obtained. For each frequency of the set of frequencies, a frequency map is obtained that indicates for the at least one pixel whether said frequency is the frequency of the set for which the obtained contrast sensitivity value is the highest. The frequency maps are then filtered, wherein at least one frequency map is filtered with a filter whose size depends on the frequency associated with said frequency map. The filtered frequency maps are finally combined into a single frequency map.

### CROSS REFERENCE TO RELATED APPLICATIONS

This application claims the benefit of European Application No. 23305558.1, filed on Apr. 13, 2023 which is incorporated herein by reference in its entirety.

### TECHNICAL FIELD

At least one of the present embodiments generally relates to a processing method for determining a frequency map of an image and a corresponding apparatus. The frequency map may be used to modify luminance of the image and thus reduce the energy consumption of a display device displaying the modified image.

### BACKGROUND

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and soon to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, Mobile phones, tablets, etc). Indeed, displays are the most important source of energy consumption, for consumer electronic devices, either battery-powered (e.g., smartphones, tablets, head-mounted displays, car display screens) or not (e.g., television sets, advertisement display panels).

Different display technologies have been developed in the recent years. As far as backlight displays are concerned, their energy consumption is largely determined by the intensity of the backlight. Organic Light Emitting Diode (OLED) is one example of display technology that is finding increasingly widespread use because of numerous advantages compared to former technologies such as Thin-Film Transistor Liquid Crystal Displays (TFT-LCDs). Rather than using a uniform backlight, OLED displays, as well as mini LEDS, are composed of individual directly emissive image pixels. OLEDs power consumption is therefore highly correlated to the image content and the power consumption for a given input image can be estimated by considering the values of the displayed image pixels.

The displays thus remain one of the most important sources of energy consumption in a video chain.

### SUMMARY

In one implementation, a frequency map is obtained for an image. In an example, the frequency map indicates for at least one pixel of the image whether a frequency is the frequency of a set of frequencies for which a contrast sensitivity value of said pixel is the highest. In an example, a frequency map is obtained for each frequency of the set of frequencies. A frequency map may thus associate its frequency's value with the at least one pixel in the case where said frequency is the one for which the contrast sensitivity value for the pixel is the highest and zero otherwise. The frequency maps may then be filtered wherein at least one frequency map is filtered with a filter whose size depends on the frequency associated with said frequency map. The filtered maps may also be combined into a single frequency map which may be further used for luminance and optionally chrominance reduction.

### BRIEF DESCRIPTION OF THE DRAWINGS

FIG. 1 depicts a flowchart of a processing method of an input video according to an example;

FIG. 2 depicts a flowchart of a processing method of a picture according to another example;

FIG. 3 illustrates a chart representing the visibility of contrast at different frequencies;

FIG. 4 depicts a flowchart of a processing method for determining a frequency map of a picture according to an example;

FIG. 5 shows an image representing a landscape;

FIG. 6 shows a frequency map derived from the image of FIG. 5;

FIG. 7 shows the frequency map of FIG. 6 after its filtering by a Gaussian filter;

FIG. 8 illustrates a flowchart of a processing method for determining a frequency map of an image according to an example; and

FIG. 9 depicts a flowchart detailing one particular step of the processing method depicted on FIG. 8; and

FIG. 10 depicts a flowchart detailing another particular step of the processing method depicted on FIG. 8;

FIG. 11 shows a frequency map determined with the processing method depicted on FIG. 8;

FIG. 12 depicts a flowchart of a method for reducing luminance and optionally chrominance of an image responsive to a frequency map; and

FIG. 13 illustrates a block diagram of a system within which aspects of the present embodiments may be implemented.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. At least one of the aspects generally relates to image processing, and at least one other aspect generally relates to transmitting a bitstream generated or encoded, or to decoding the transmitted bitstream. These and other aspects can be implemented as a method, an apparatus, a computer readable storage medium having stored thereon instructions for processing video data according to any of the methods described, and/or a computer readable storage medium having stored thereon a bitstream or processed video data generated according to any of the methods described.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

For the sake of clarity, satisfying, failing to satisfy a condition and configuring condition parameter(s) are described throughout embodiments described herein as relative to a threshold (e.g., greater, or lower than), a (e.g., threshold) value, configuring the (e.g., threshold) value, etc.). For example, satisfying a condition may be described as being above a (e.g., threshold) value, and failing to satisfy a condition (e.g., performance criteria) may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Light production in display devices (for example: televisions, smartphones, tablets, laptops, cameras) is costly. Although described in the context of display devices based on OLED technology, the present principles are not limited to this context and also apply to other types of displays such as local dimming LED displays, mini-LED displays and micro-LED displays. The examples disclosed also apply to MEMs-based display technologies.

Reduction of the amount of light produced is desirable, as this helps to reduce the amount of energy necessary to operate the display. However, the reduction has to be perceptually invisible, i.e. below visible threshold, to the end-user. The advantage of this reduction can be two-fold: less pressure on the climate, and longer battery life in mobile devices. To ensure that the processing remains below visible threshold, the amount by which each pixel is changed has to be less than 1 just-noticeable difference (JND). Examples described herein use both terms of “just-noticeable differences” (JNDs) and “minimum detectable modulation” (MDM). Although expressed differently, these terms correspond to one and the same concept. It represents, for a pixel x, a threshold value of luminance variations, i.e. a luminance variation smaller than this threshold value will not be perceived by a typical viewer, while a luminance variation greater than this threshold value may be perceived by the viewer. The relationship between the two terms can be expressed as follows:

$$JND = L ( x ) - L ( x ) * \frac{1 - m ( x )}{1 + m ( x )}$$

where JND is the just-noticeable difference, m(x) is the minimum detectable modulation for a pixel x, and L(x) is the luminance for this pixel. Both terms may be used interchangeably. In the following, x is used to designate both the pixel and its spatial location in the image. A per-pixel JND can be computed using the steps outlined below, noting that the pixel luminance as well as a measure of local contrast may be used as input to this computation. To know how much contrast is available at a given pixel in a given image, a pixel-wise frequency map can be built which can be used subsequently to process an image such that when displayed on a screen, the screen uses less energy. More precisely, the frequency map may be used to reduce pixel-wise luminance values (and possibly chrominance values) of an image such that when displayed on a screen, the screen uses less energy. In a transmission scenario, frequency maps may be determined on a transmitter side, e.g. by a broadcaster or more generally by an apparatus transmitting the video, while the luminance reduction may be performed responsive to received frequency maps on an end-user side, e.g. by an end-user display.

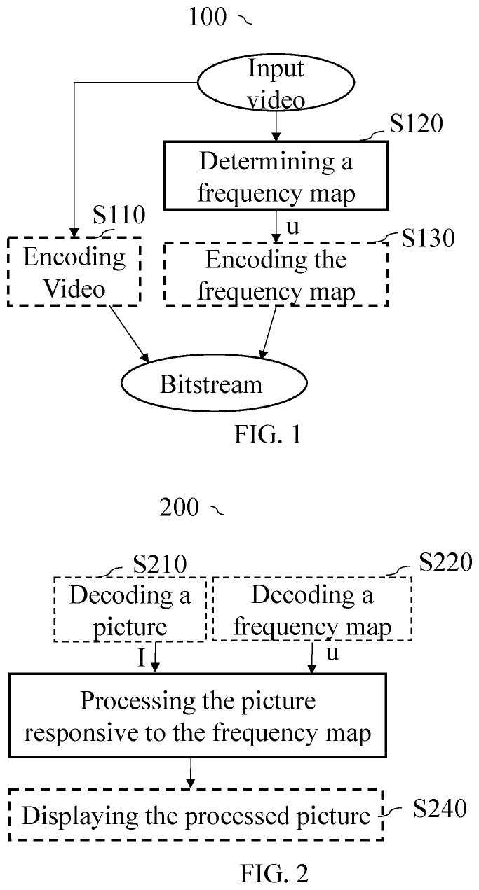

FIG. 1 depicts a flowchart of a processing method 100 of an input video according to an example. The processing method 100 may be performed on a transmitter side, e.g. by a broadcaster or more generally by an apparatus transmitting the input video.

At an optional step S110, the input video is encoded in a bitstream. The bitstream may be conform to a video coding standard, e.g. ECM, VVC or HEVC. The present aspects relating to encoding/decoding are not limited to VVC or HEVC, and can be applied, for example, to other standards and recommendations, whether pre-existing or future-developed, and extensions of any such standards and recommendations (including VVC and HEVC). Encoding the input vide comprises encoding the pictures of the video. Encoding a picture may comprise reconstructing the picture to provide a reference for further predictions.

At step S120, a frequency map is determined for at least one picture of the video. In an example, a frequency map is determined for each picture of the video. The frequency map may be determined from a picture of the input video. In a variant, the frequency map may be determined from a corresponding reconstructed picture.

At an optional step S130, the frequency map is encoded in the bitstream, e.g. as a SEI message (Supplemental Enhancement Information) or more generally is attached to the bitstream as metadata.

The step S120 to S130 may be applied to all pictures of the input video. The processing method 100 may be applied to a still picture instead of a video. In this case, the still picture is optionally encoded at S110, a frequency map is determined at S120 from the still picture and the frequency map is optionally encoded at S130.

FIG. 2 depicts a flowchart of a processing method 200 of a picture according to another example. The processing method 200 may be performed on a receiver side, e.g. by an end-user display.

At an optional step S210, the picture is decoded from a received bitstream. The step S210 is the reverse of step S110. In another example, the decoded picture is obtained from a storage medium.

At an optional step S220, the frequency map is decoded from the received bitstream. The step S220 is the reverse of step S130. In another example, the frequency map is obtained from a storage medium.

At a step S230, the picture is processed responsive to the frequency map. In an example, the luminance of the picture is reduced responsive to the frequency map. In another example, both the luminance and chrominance are reduced responsive to the frequency map.

Optionally, the picture may be processed at S230 responsive to the frequency map and to additional parameters, e.g. the peak luminance of the display.

At an optional step S240, the processed picture is displayed. Since the luminance (and optionally chrominance) are reduced, displaying the image requires less energy.

The step S210 to S240 may be applied to all pictures of a video.

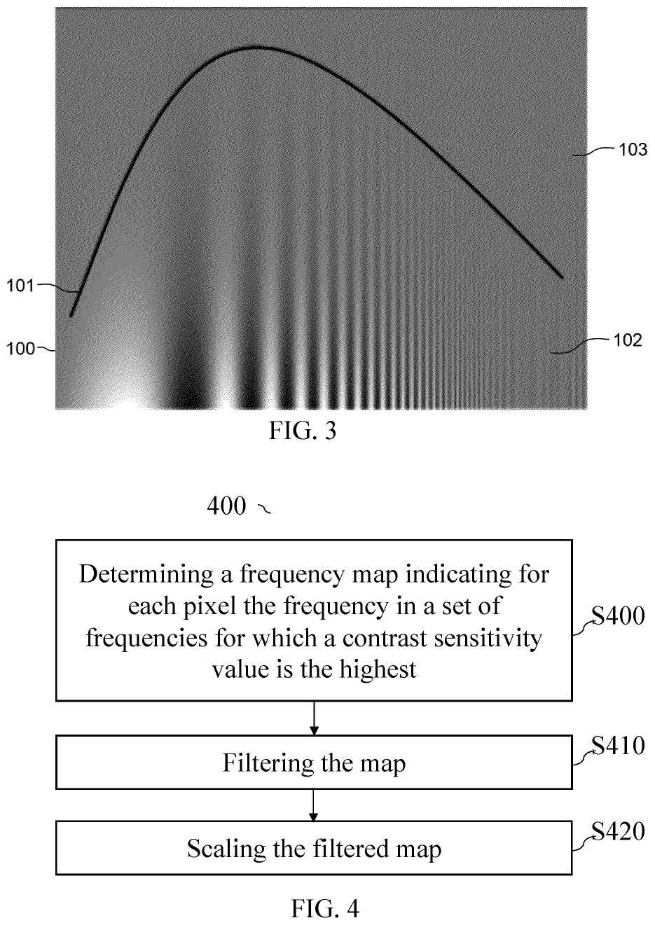

FIG. 3 illustrates a chart representing the visibility of contrast at different frequencies. A contrast sensitivity function (CSF) is a model of human vision that predicts which contrasts at which frequencies are visible to the human eye. The visibility of contrast depends both on the frequency and on the magnitude of the contrast as shown in FIG. 3. In this figure, the chart 100 is a Campbell-Robson chart in which luminance is modulated according to a sinus function which linearly increases in frequency from left to right, and linearly increases in magnitude from top to bottom. The curve 101 represents the frontier for which the contrast is just barely visible. Thus, the lower part 102 represents the area where the contrast is visible while the upper part 103 represents the area where the contrast is not visible. Note that humans are most sensitive to contrasts of about 1-2 cycles per degree. Therefore, modifications of an image may be unnoticed if done within the area 103.

There are a number of models available for modeling contrast sensitivity. Barten's model (Barten, Peter GJ. Contrast sensitivity of the human eye and its effects on image quality. SPIE press, 1999) tends to be seen as the most complete model, and other models are often validated by comparison against this model. Barten's CSF model (CSF stands for Contrast Sensitivity Function) can be summarized as follows. The contrast sensitivity S(L, u) as function of luminance L and frequency u is given by equation 1:

$$S ( L , u ) = \frac{{M}_{opt} ( u ) / k}{\sqrt{\frac{2}{T} ( \frac{1}{{X}_{0}^{2}} + \frac{1}{{x}_{max}^{2}} + \frac{{u}^{2}}{{N}_{max}^{2}} ) ( \frac{1}{η pE} + \frac{{Φ}_{0}}{1 - {e}^{- {( u / {u}_{0} )}^{2}}} )}} \qquad ( eq \text{.1} )$$

$$where$$

$${M}_{opt} ( u ) = {e}^{- 2 {π}^{2} {σ}^{2} {u}^{2}}$$

$$σ = \frac{\sqrt{{σ}_{0}^{2} + {( {C}_{ab} d )}^{2}}}{60}$$

$$d = 5 - 3 tanh ( 0.4 log ( \frac{{LX}_{0}^{2}}{4 {0}^{2}} ) )$$

$$E = \frac{π {d}^{2}}{4} L ( 1 - {( \frac{d}{9.7} )}^{2} + {( \frac{d}{12.4} )}^{4} )$$

The following constants are also specified:

$$k = 3.$$

$${σ}_{0} = 0.5 arc min$$

$${C}_{ab} = 0.08 arc min / mm$$

$$T = 0.1 s$$

$${X}_{max} = 12 °$$

$${X}_{0} = 40 °$$

$${N}_{max} = 15 cycles$$

$$η = 0.03$$

$${Φ}_{0} = 3 \times {10}^{- 8} s {deg}^{2}$$

$${u}_{0} = 7 cycles / deg$$

$$p = 1.2 \times {10}^{6} photons / s / {deg}^{2} / Td$$

This model is independent of the content of the image and thus may either be computed in the device or predetermined and loaded from memory.

An input image is typically specified as an 8 bit SDR image, or perhaps a 10- or 12-bit HDR image. Nominally, the codeword values in an SDR image encode a luminance range between 0 and 100 cd/m². The codeword values in an HDR image may encode a larger range, for example between 0 and 10000 cd/m². As Barten's model is specified in absolute luminance values, the input RGB image is first converted to linear XYZ, and a luminance-only image L is derived from the Y channel of the RGB image. For SDR images, this luminance image is scaled to be between 0 and 100. If the input image is an HDR image, the luminance image is scaled according to the assumed peak luminance.

FIG. 4 illustrates a flowchart of a processing method 400 for determining a frequency map of an image according to an example.

In a step S400, a frequency map u is determined. The frequency map u indicates, for each pixel at spatial location x of the image, the frequency uᵢ (a.k.a angular frequency) in a set of frequencies {uᵢ}_{i=1 . . . N, e.g. N=}10, for which a local contrast sensitivity value CSF(x, uᵢ) is the highest. In one example, CSF(x, uᵢ)=DWT(x, uᵢ)S(L, uᵢ), where DWT(x, uᵢ) is a wavelet coefficient associated with pixel x in level i. CSF(x, uᵢ) is thus a contrast sensitivity value weighted by DWT(x, uᵢ). To this aim, the input image is decomposed by a wavelet transform on N levels (a.k.a wavelet levels or scales). Such a decomposed image gives information about how much there is of each frequency uᵢ at a given pixel location x.

The relation between wavelet level i and angular frequency uᵢ is given as follows:

$${u}_{i} = \frac{π}{180} \frac{0.5}{{2}^{i}} d \frac{{n}_{x}}{s}$$

where d is the distance between viewer and screen, s is the horizontal size of the screen, and nₓ represents the number of screen pixels in the horizontal direction. The value

$$d \frac{{n}_{x}}{s}$$

may be set to a constant value, e.g. 2206. This value would be appropriate for a 50 inch HD display viewed at a distance of 2.3 meters (d=2.3, s=1.3, nₓ=1024), noting that the horizontal size of a 50 inch display is 1.3 meters.

In many graphics applications a simple discrete wavelet transform, usually incorporating a Haar wavelet, may be used. However, the tradeoff between spatial localization and frequency analysis is sub-optimal when using such a simple discrete wavelet transform. Other wavelets may thus be used instead, e.g. for example based on the following wavelet families: Daubechies, coiflets, symlets, Fejér-Korovkin, Discrete Meyer, or (reverse) biorthogonal.

Let S(L(x), uᵢ) be the result of applying a contrast sensitivity function S( ) with L(x) the luminance of a pixel at location x and uᵢ a frequency (at wavelet level i). The frequency value u(x) for pixel at location x is a frequency to which the human visual system would be most sensitive and is defined as follows:

$$u ( x ) = {arg max}_{{u}_{i}} DWT ( x , {u}_{i} ) S ( L ( x ) , {u}_{i} )$$

As there are N wavelet levels i (and thus N frequencies uᵢ), the frequency map u comprises at most N different values which are logarithmically spaced. In an example, 10 levels are considered. In this case, the optimization can be made in a brute force manner, i.e. p=DWT(x, uᵢ)S(L, uᵢ) may be evaluated for all 10 wavelet levels, and for every pixel the angular frequency uᵢ with the highest response p is recorded.

In a variant, a continuous wavelet transform (CWT) may be used instead of DWT. As the sensitivity of the human visual system is not significantly orientation-dependent, a continuous wavelet transform using the anisotropic Mexican hat wavelet may give good results without expending more computing cycles than necessary. A large number of other wavelet mother functions are available in the context of a 2-dimensional CWT and could be used such as the Morlet wavelet, the halo and arc wavelets, the Cauchy wavelet, the Poisson wavelet. As the interest is in image analysis, whereby the occurrence of frequencies often coincides with the presence of edges, a wavelet function which performs well for edge detection is a reasonable choice. Further, a CWT can be carried out at any desired orientation. Anisotropic wavelet functions could be chosen so that frequencies at different orientations could be favored. Human vision is also known to be anisotropic in the sense that it is more sensitive to horizontal and vertical edges. However, the difference in sensitivity to horizontal/vertical edges and diagonal edges is not sufficiently significant to warrant an orientation-selective frequency analysis. As such, an isotropic wavelet may be chosen, as the computational cost of the wavelet analysis will be significantly lower. Considering these constraints, the Mexican Hat wavelet is an appropriate choice. In addition, this isotropic wavelet produces a real-valued output.

In an example, CSF(x, uᵢ)=CWT(x, uᵢ)S(L, uᵢ). The frequency map is determined using a continuous wavelet transform CWT(x, uᵢ), where x is a (spatial) image location, and uᵢ is an angular frequency associated with wavelet level i. The frequency value u(x) for pixel at location x is a frequency to which the human visual system would be most sensitive, i.e.

$$u ( x ) = {arg max}_{{u}_{i}} CWT ( x , {u}_{i} ) S ( L ( x ) , {u}_{i} ) .$$

At S410, the frequency map is filtered. Indeed, the per-pixel frequency map determined at S400 according to

$$u ( x ) = {arg max}_{{u}_{i}} CWT ( x , {u}_{i} ) S ( L ( x ) , {u}_{i} )$$

contains discontinuities. Due to the halving of angular frequency uᵢ with wavelet level i, the sizes of these discontinuities may be sometimes very large, and sometimes very small. Indeed, the relationship between wavelet level i and angular frequency uᵢ is exponential. This means that for every next wavelet level, the angular frequency halves. The description below is based on a Gaussian filter but other types of filters could be used such as box filters, tent filters, cubic filters, sinc filters, bilateral filters, etc. The standard deviation σ of the filter's kernel is empirically determined to be:

$${σ}_{g} = \frac{max ( {N}_{x} , {N}_{y} )}{12} ,$$

where Nₓ and N_{y} are the horizontal and vertical resolutions of the input image.

The Gaussian smoothing kernel G is given by:

$$G ( x , y ) = \frac{1}{2 π {σ}_{g}^{2}} {e}^{- \frac{{x}^{2} + {y}^{2}}{2 {σ}_{g}^{2}}} .$$

The smoothed frequency map u′ is thus obtained as follows: u′=u⊗G, wherein ⊗ is a convolutional operator.

At an optional step S420, the filtered map is scaled. Indeed, the filtering may have undesirable side effect, which is that the range of values of u′ is reduced relative to the range of values in u. The filtered frequency map u′ may thus be scaled as follows:

$${u}^{″} = {u}^{′} \frac{max ( u )}{max ( {u}^{′} )}$$

This scaling of the filtered frequency map represents an appropriate solution for still images. However, for video content the scaling by the ratio of maxima in u and u′ may lead to temporal artefacts, notably flicker. Temporal artefacts may be remedied by subjecting these maxima to a process known as leaky integration. Assuming that subscript t indicates image number, and that the scaling for image t−1 is given by Sₜ₋₁, the scaling for the current image is thus given by sₜ:

$${s}_{t} = α {s}_{t - 1} + ( 1 - α ) \frac{max ( u )}{max ( {u}^{′} )}$$

The scaled frequency map for image t is then determined as

$${u}_{t}^{″} = {u}_{t}^{′} {s}_{t} .$$

For video content, this is an appropriate solution for scaling the frequency map. The value of α is in the range [0; 1]. An example value is given by α=0.8.

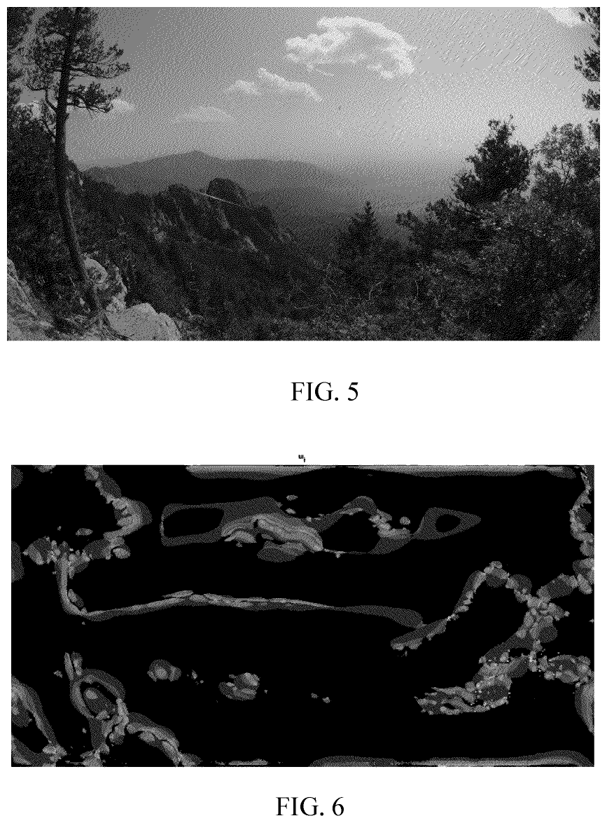

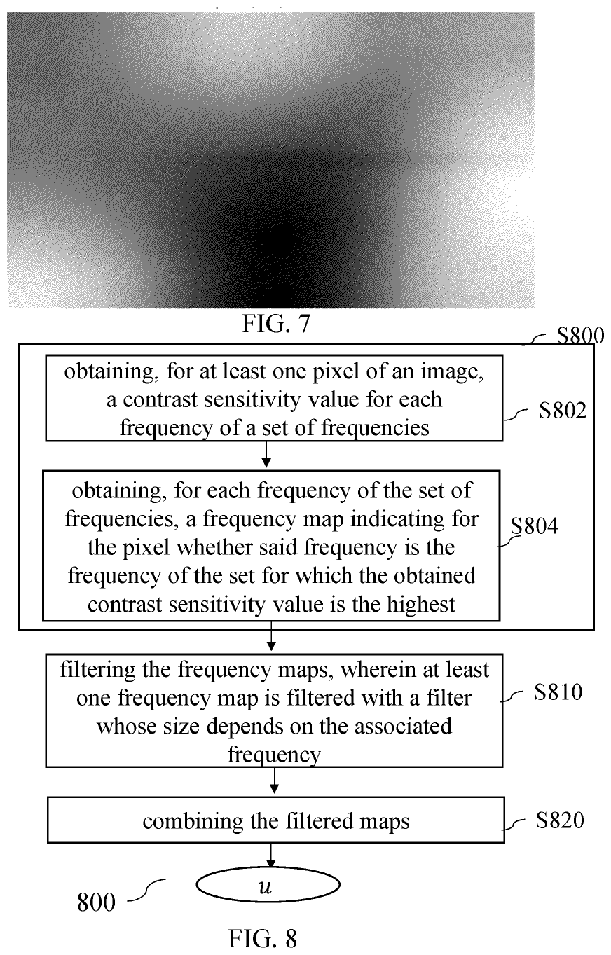

FIG. 5 shows an input image. FIG. 6 shows the map of frequencies that results from applying the processing method 400 with a continuous wavelet transform. This frequency map is shown in log-space for visualization purposes. The filtered frequency map u′ is depicted on FIG. 7, wherein u′ is obtained by filtering the frequency map u with a Gaussian filter having a very large filter kernel to produce a globally smooth map. Due to the exponential progression in angular frequency values, the filter kernel size needs to be very large to create a smooth image, so that the final result of the pixel value reduction method does not reveal spatial artefacts. However, in image areas containing high angular frequencies, the method 400 depicted on FIG. 4 removes too much detail from the frequency map. Said otherwise, to avoid spatial artefacts, the Gaussian filter removes too much detail in high frequency regions. Consequently, when using such a filtered frequency map to process a picture, e.g. to reduce luminance, a sub-optimal reduction of pixel values is obtained in those regions of the frequency map where too much detail has been removed.

In contrast, a processing method is disclosed below whereby the spatial filter kernel size co-varies non-linearly with the frequency values uᵢ allowing a form of non-destructive filtering, so that near high values in the data the filter kernel becomes smaller. In addition, this method is particularly suitable for cases whereby the number of different levels in the image is limited (e.g. 10 different levels), and cases whereby these levels are exponentially distributed. In this latter case, each new level has associated with it half the frequency of the preceding level.

FIG. 8 illustrates a flowchart of a processing method 800 for determining a frequency map of an image according to an example.

A step S800, one frequency map Mᵢ is obtained for each frequency uᵢ of a set of frequencies {uᵢ}_{i=1 . . . N}, e.g. N=10. Each map Mᵢ associates a value Mᵢ(x) with at least one pixel x of the image, the value indicating for the pixel whether the frequency uᵢ is the frequency for which a contrast sensitivity value obtained for the pixel x is the highest. In a variant, each map Mᵢ associates a value Mᵢ(x) with each pixel x of the image.

More precisely, at S802, a weighted contrast sensitivity value CSF(x, uᵢ) is obtained for the pixel x and for each frequency uᵢ of the set of frequencies. In an example, CSF(x, uᵢ)=CWT(x, uᵢ)S(L(x), uᵢ). In another example, CSF(x, uᵢ)=DWT(x, uᵢ)S(L(x), uᵢ). In a variant, CSF(x, uᵢ) is obtained for all pixels x of the image and for each frequency uᵢ of the set of frequencies.

At S804, a frequency map Mᵢ is obtained from the contrast sensitivity values obtained for the pixel x (respectively for all pixels of the image). The frequency map Mᵢ indicates for the pixel x whether the frequency uᵢ is the frequency of the set for which the obtained contrast sensitivity value CSF(x, uᵢ) is the highest. For a given pixel x, all entries Mᵢ(x) are set to zero, except for the entry i where the response p, i.e. the weighted contrast sensitivity value CSF(x, uᵢ), is the highest. For this entry, the value in the map is set equal to the frequency uᵢ associated with the level i for which the highest response was found. The result of this operation is that for each level i (or equivalently for each frequency of the set) there is a map Mᵢ which contains for at least one pixel (or for each pixel of the image) only one of two possible values: 0 or uᵢ. At S810, each map Mᵢ is filtered. At least one map is filtered with a filter kernel of size of that depends on the associated frequency uᵢ. In an example, each map Mᵢ is filtered with a filter kernel of size σᵢ that depends on its associated frequency uᵢ. In another example, all maps Mᵢ for which σᵢ=σₘₐₓ (e.g. σₘₐₓ=512) are first combined into a single map and then filtered with a filter kernel of size σₘₐₓ.

In one example, each map Mᵢ is filtered individually. Consequently, each map may be filtered with a different filter kernel. Moreover, this offers the possibility to associate the size σᵢ of the filter kernel with the frequency values uᵢ available in map Mᵢ. The size σᵢ may be chosen so that for high spatial frequencies uᵢ the filter parameter σᵢ will be small and vice-versa. At S820, the filtered maps Mᵢ′ are combined into a single map M′. In an example, the filtered maps are summed as follows:

$${M}^{′} = {\sum }_{i} {M}_{i}^{′}$$

The values in map M′ are now representative of an angular frequency u. The scaling step S420 may optionally be applied to M′. For a given pixel x, the value u(x)=M′(x).

The processing method 800 is particular in the sense that the size of the filter kernel for a given pixel is related to the frequency at that pixel to which the human visual system is most sensitive. An advantage of this processing method is that the filtering is adaptive to the content of an image, allowing low frequency values to be blurred more than high frequency values.

In more general terms, this method enables filtering of data whereby the filter parameter is related to the magnitude of the data. Note that this form of filtering is not the same as an edge-stopping filter (such as the bilateral filter), as such methods vary the size of the filter kernel as function of spatial distance to an edge.

Finally, note that in the above formulation the relationship between filter kernel size σᵢ and angular frequency uᵢ is non-linear. This precludes the use of a much simpler filtering operation, in which all frequency values for all pixels would be grouped in a single map, and this map would be filtered in log-space.

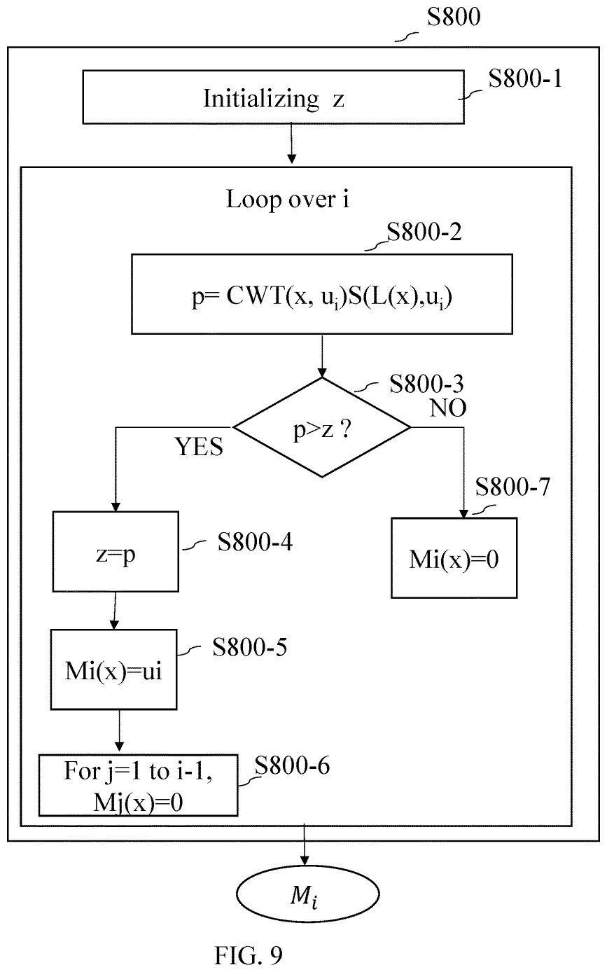

FIG. 9 is a flowchart that details S800.

At S800-1, a parameter z is initialized to a negative value, e.g. to −1.

The steps S800-2 to S800-7 are iterated over the wavelet levels i.

At S800-2, p is computed as follows: p=CWT(x, uᵢ)S(L, uᵢ)

At S800-3, z is compared with p. In the case where p>z, z is set equal to p (S800-4). The parameter z is thus used to keep track of the level (or of the frequency uᵢ) for which the response p is the highest. At S800-5, the value in Mᵢ(x) is set to uᵢ. At S800-6, for j=1 to i−1, Mj(x)=0.

Therefore, the map values for pixel at location x are set to zero for all previous levels, i.e. for all levels j wherein j<i. Otherwise (S800-7), Mᵢ(x)=0.

In a variant CWT may be replaced by DWT. This loop S800 maybe executed for all pixels in the image.

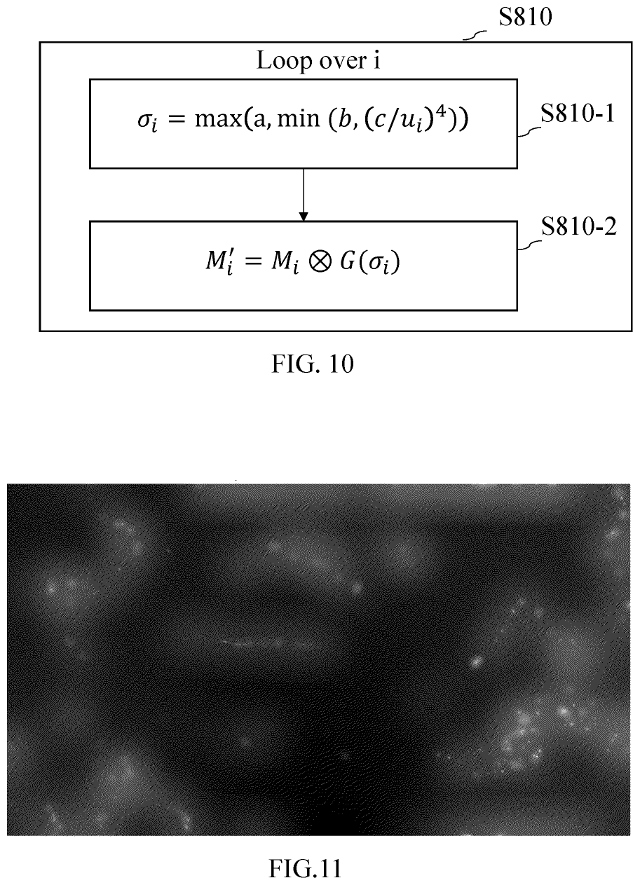

FIG. 10 is a flowchart that details S810.

At S810-1, the size of the filter kernel is determined responsive to the frequency uᵢ associated with the map Mᵢ to be filtered: σᵢ=g(uᵢ). Experiments have shown that for images of decent size, for example HD or 4K, the size of the filter kernel σᵢ can be tied to the angular frequency uᵢ as follows: σᵢ=max(a, min(b, (c/uᵢ)⁴)). In an example, a=1, b=512 and c=10.

At S810-2, the map Mᵢ is convolved with a Gaussian filter of parameter σᵢ:

$${M}_{i}^{′} = {M}_{i} ⊗ G ( {σ}_{i} )$$

Other types of filtering could be used such as box filters, tent filters, cubic filters, sinc filters, bilateral filters, etc. An example of such filtered frequency map is depicted on FIG. 11 corresponding to the picture of FIG. 5. This filtered frequency map comprises more details than the picture on FIG. 7.

In a specific example, not depicted on FIG. 10, the frequency maps Mᵢ for which σᵢ=b are first summed into a single map Mᵢₙₜ which is filtered with a Gaussian filter of parameter σ=b.

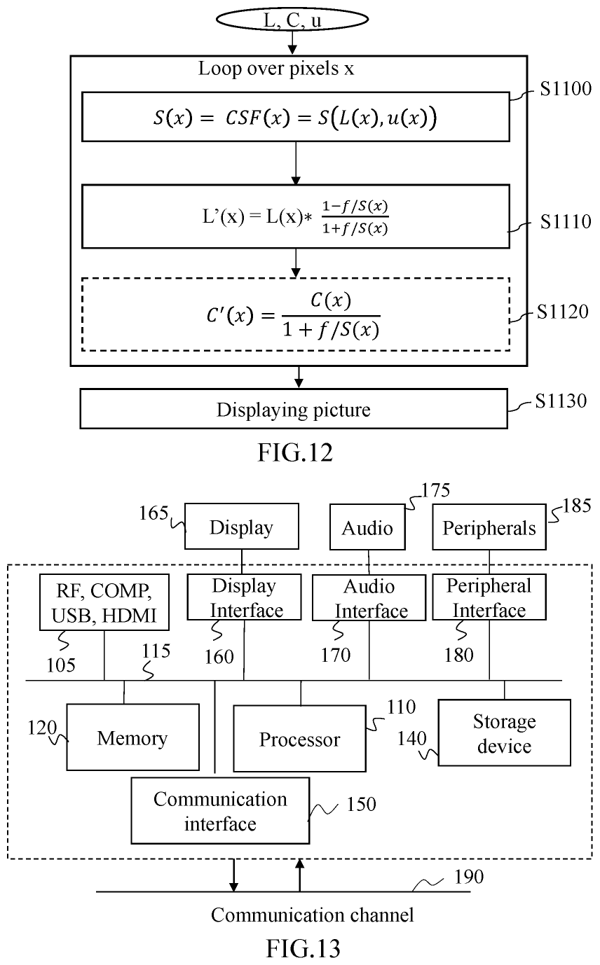

FIG. 12 depicts a flowchart of a method for reducing luminance and optionally chrominance of an image responsive to the obtained frequency map u.

At S1100, a contrast sensitivity value is determined for a pixel x, e.g. as follows:
S(x)=CSF(x)=S(L(x),u(x)), where L(x) is the luminance of pixel x and u(x) is the frequency value associated with pixel x in the frequency map. The function S( ) may be defined as the Barten's contrast sensitivity function.

At S1110, the luminance value of pixel x is then reduced by an amount related to the contrast sensitivity for that pixel. In an example, the reduced value L′(x) is set equal to L(x)r(x). In an example,

$$r ( x ) = \frac{1 - fm ( x )}{1 + fm ( x )} = \frac{1 - f / S ( x )}{1 + f / S ( x )} ,$$

where f is a modulation factor, e.g. f=0.9.

At an optional step S1120, each chrominance value of pixel x is then reduced by an amount related to the contrast sensitivity for that pixel:

$${C}^{′} ( x ) = \frac{C ( x )}{1 + f / S ( x )} .$$

At an optional step S1130, the picture after luminance and possibly chrominance reduction is displayed.

With the above formulation, each new pixel will be less than 1 JND lower in value than before. Given that Barten's model was used, high luminance pixels will be reduced more than low luminance pixels. Frequency sensitivity is built in through the use of a DWT or CWT (noting that other frequency determination methods could be substituted instead).

The principles described above guarantees that the visibility of the processing remains below the threshold as long as f is chosen to be less than 1.

The luminance and optionally chrominance reduction could be performed at various places in the imaging pipeline. For example, the method could be employed prior to encoding, so that a visually equivalent image/video is transmitted. The method could also be employed in a user device, for example a set-top box or Blu-ray player after decoding. In either case, the result is that the display produces less light, and therefore consumes less energy, while guaranteeing that the visual quality of the image/video is maintained.

The impact of the reduction can be tailored to different needs, by adapting the modulation factor f. Indeed, with f=1, the reduction of light will be perceptually indistinguishable. For some specific usage (for example in critical viewing applications such as for example encountered in post-production), a margin could be introduced with a modulation factor f lower than 1.0 leading to less light reduction and thus less energy consumption reduction. For example, a modulation factor f=0.9 or f=0.5 may be used. On the opposite, when energy reduction is very important, a modulation factor f greater than 1.0 could be used. For example, a modulation factor f=1.5 or f=2.0 may be used. In this case, the pixel modification may become visible, but the energy reduction will be more important.

FIG. 13 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 may optionally include a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

Program code to be loaded onto processor 110 to perform the various aspects described in this application may be stored in storage device 140 and subsequently loaded onto memory 120 for execution by processor 110. In accordance with various embodiments, one or more of processor 110, memory 120, storage device 140 may store one or more of various items during the performance of the processes described in this application. Such stored items may include, but are not limited to, the input video, frequency maps, the decoded video or portions of the decoded video, the bitstream, matrices, variables, and intermediate or final results from the processing of equations, formulas, operations, and operational logic.

In some embodiments, memory inside of the processor 110 is used to store instructions and to provide working memory for processing. In other embodiments, however, a memory external to the processing device is used for one or more of these functions. The external memory may be the memory 120 and/or the storage device 140, for example, a dynamic volatile memory and/or a non-volatile flash memory. In several embodiments, an external non-volatile flash memory is used to store the operating system of a television.

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 13, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, optionally including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated with a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS(HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals, e.g. in an SEI message, a particular one of a plurality of frequency map. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

In an example, a processing method is disclosed that comprises:
obtaining, for at least one pixel of an image, a contrast sensitivity value for each frequency of a set of frequencies;
obtaining, for each frequency of the set of frequencies, a frequency map indicating for the at least one pixel whether said frequency is the frequency of the set for which the obtained contrast sensitivity value is the highest;
filtering the frequency maps, wherein at least one frequency map is filtered with a filter whose size depends on the frequency associated with said frequency map; and combining the filtered frequency maps into a single frequency map.

In an example, an apparatus comprising one or more processors and at least one memory coupled to said one or more processors is disclosed. The one or more processors are configured to perform:
obtaining, for at least one pixel of an image, a contrast sensitivity value for each frequency of a set of frequencies;
obtaining, for each frequency of the set of frequencies, a frequency map indicating for the at least one pixel whether said frequency is the frequency of the set for which the obtained contrast sensitivity value is the highest;
filtering the frequency maps, wherein at least one frequency map is filtered with a filter whose size depends on the frequency associated with said frequency map; and combining the filtered frequency maps into a single frequency map.

In an example, obtaining, for each frequency of the set of frequencies, a frequency map comprises associating the frequency's value with the at least one pixel in the case where said frequency is the one for which the contrast sensitivity value for said at least one pixel is the highest and zero otherwise.

In an example, obtaining, for at least one pixel of an image, a contrast sensitivity value for each frequency of a set of frequencies comprises:
applying a wavelet transform on said image to decompose the image onto said set of frequencies; and
determining, for the at least one pixel, a contrast sensitivity value for each frequency of the set as a product of a wavelet coefficient for said pixel at said frequency by a value of a contrast sensitivity function.

In an example, said contrast sensitivity function is a Barten's contrast sensitivity function.

In an example, said filter is a gaussian filter.

In an example, the size of the filter is equal to max (a, min (b, (c/uᵢ)+)), where a, b and c are constant values.

1. A processing method comprising:
obtaining, for at least one pixel of an image, a contrast sensitivity value for each angular frequency of a set of angular frequencies;
obtaining, for each angular frequency of the set of angular frequencies, a frequency map indicating for the at least one pixel whether the angular frequency is the angular frequency of the set for which the obtained contrast sensitivity value is the highest;
filtering each frequency map with a filter whose kernel size depends on the angular frequency associated with the frequency map;
combining the filtered frequency maps into a single frequency map by summing the filtered frequency maps; and
transmitting the single frequency map to an end-user.

2. The method of claim 1, wherein obtaining, for each angular frequency of the set of angular frequencies, a frequency map comprises associating the angular frequency with the at least one pixel in the case where the angular frequency is the one for which the contrast sensitivity value for the at least one pixel is the highest and zero otherwise.

3. The method of claim 1, wherein obtaining, for at least one pixel of an image, a contrast sensitivity value for each angular frequency of a set of angular frequencies comprises:
applying a wavelet transform on the image to decompose the image onto the set of angular frequencies; and
determining, for the at least one pixel, a contrast sensitivity value for each angular frequency of the set as a product of a wavelet coefficient for the pixel at the angular frequency by a value of a contrast sensitivity function.

4. The method of claim 3, wherein the contrast sensitivity function is a Barten's contrast sensitivity function.

5. The method of claim 1, wherein the filter is a gaussian filter.

6. The method of claim 1, wherein the kernel size of the filter is equal to max(a, min(b, (c/uᵢ)⁴)), where a, b and c are constant values.

7. An apparatus comprising one or more processors and at least one memory coupled to the one or more processors, wherein the one or more processors are configured to perform:
obtaining, for at least one pixel of an image, a contrast sensitivity value for each angular frequency of a set of angular frequencies;
obtaining, for each angular frequency of the set of angular frequencies, a frequency map indicating for the at least one pixel whether the angular frequency is the angular frequency of the set for which the obtained contrast sensitivity value is the highest;
filtering each frequency map with a filter whose kernel size depends on the angular frequency associated with the frequency map;
combining the filtered frequency maps into a single frequency map by summing the filtered frequency maps; and
transmitting the single frequency map to an end-user.

8. The apparatus of claim 7, wherein obtaining, for each angular frequency of the set of angular frequencies, a frequency map comprises associating the angular frequency with the at least one pixel in the case where the angular frequency is the one for which the contrast sensitivity value for the at least one pixel is the highest and zero otherwise.

9. The apparatus of claim 7, wherein obtaining, for at least one pixel of an image, a contrast sensitivity value for each angular frequency of a set of angular frequencies comprises:
applying a wavelet transform on the image to decompose the image onto the set of angular frequencies; and
determining, for the at least one pixel, a contrast sensitivity value for each angular frequency of the set as a product of a wavelet coefficient for the pixel at the angular frequency by a value of a contrast sensitivity function.

10. The apparatus of claim 9, wherein the contrast sensitivity function is a Barten's contrast sensitivity function.

11. The apparatus of claim 7, wherein the filter is a gaussian filter.

12. The apparatus of claim 7, wherein the kernel size of the filter is equal to max(a, min(b, (c/uᵢ)⁴)), where a, b and c are constant values.

13. (canceled)

14. A non-transitory computer readable storage medium having stored thereon instructions for implementing the method of claim 1.
